(19) United States
(12) Patent Application Publication
(10) Pub. No.: US 2009/0154482 A1
(43) Pub. Date: Jun. 18, 2009

(54) ROUTING METHOD IN SENSOR NETWORK

(76) Inventors: Young Hwan Ham, Daejeon-city (KR); Hyeon Park, Daejeon-city (KR); Sang Joon Park, Daejeon-city (KR); Cheol Sig Pyo, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/336,478

(22) Filed: Dec. 16, 2008

(30) Foreign Application Priority Data
Dec. 17, 2007 (KR) 10-2007-0132714

(51) Int. Cl. H04L 12/56

(52) U.S. Cl. 370/408

(57) ABSTRACT

Provided is a routing method capable of expanding a conventional tree routing to perform the efficient and safe key management in a sensor network environment that requires the symmetric key based key management. Each sensor node transmits a Route Reverse message to a sink node to set a reverse tree routing path. Therefore, it is possible to provide efficient and safe key management mechanism and communication environment by providing a bidirectional communication between a sink node and sensor nodes through an expanded tree routing such that a user is provided with a safe sensor network.

### CROSS-REFERENCE TO RELATED PATENT APPLICATION

This application claims the benefit of Korean Patent Application No. 10-2007-0132714, filed on Dec. 17, 2007, in the Korean Intellectual Property Office, the disclosure of which is incorporated herein in its entirety by reference.

### BACKGROUND OF THE INVENTION

1. Field of the Invention

The present invention relates to a routing method, and more particularly, to a tree routing method for setting a secret information transmission path between nodes while establishing a pairwise key in a sensor network.

2. Description of the Related Art

A tree routing operates as follows in a conventional sensor network.

Each node included in a sensor network broadcasts a HELLO message. Neighbor nodes of a sink node select the sink node as a parent node through the broadcast message. Every node selects its parent node by repeating such a process, and eventually every node can set a path to the sink node through the parent node connection.

In a typical tree routing in a sensor network, a routing path is determined in a direction from each node to a sink node. However, since a path cannot be determined in a direction from a sink node to each node, in this case it is necessary to transmit a message through broadcasting.

The tree routing is useful in an environment where messages are mainly transmitted to a sink node. However, it is difficult to apply the tree routing in the case where a sink node should transfer commands to each node or exchange messages with each node to manage a symmetric key for security.

### SUMMARY OF THE INVENTION

The present invention provides a routing method capable of expanding a conventional tree routing to perform efficient and safe key management in a sensor network environment that requires the symmetric key based key management.

The present invention also provides an efficient message exchange method for the case where memory for a routing table is not sufficient.

The present invention also provides a routing method supporting more efficient bidirectional communication while maintaining the characteristics and advantages of a conventional tree routing algorithm in a sensor network.

According to an aspect of the present invention, there is provided a routing method in a sensor network, the method comprising: setting a tree routing path to a sink node by determining, at each node in the sensor network, a parent node based on a HELLO message broadcasted by the sink node; and setting a reverse tree routing path from the sink node by transmitting, at each node which has determined a parent node, a Route Reverse message considering the sink node as a final node to the parent node along the tree routing path.

According to another aspect of the present invention, there is provided a routing method of setting an information transmission path for establishing a pairwise key in a sensor network of a tree structure, the method comprising: transmitting, at each of a source node and a destination node to establish a pairwise key, a Route Reverse message including its identifying information and considering a sink node as a final node in a parent node direction of the tree structure; generating, at nodes having received the Route Reverse message on the transmission path, an entry of a routing table based on the identifying information and identifying information of an directly connected lower child node; and transmitting, at the source node, information for establishing the pairwise key to the destination node through the sink node using a reverse tree routing path set based on the routing table.

The invention can also be embodied as a computer readable recording medium for embodying the routing method in a sensor network.

Additional advantages and features of the invention will be set forth in part in the description which follows and in part will become apparent to those having ordinary skill in the art upon examination of the following or may be learned from practice of the invention.

### BRIEF DESCRIPTION OF THE DRAWINGS

The above and other features and advantages of the present invention will become more apparent by describing in detail exemplary embodiments thereof with reference to the attached drawings in which:

FIGS. 1 through 4 are views illustrating a method of establishing a pairwise key between two nodes in a sensor network system according to an embodiment of the present invention;

FIG. 5 is a flowchart illustrating a method of setting a reverse tree routing path in a sensor network according to an embodiment of the present invention; and

FIG. 6 is a flowchart illustrating a method of setting a path for information transmission between any two nodes to establish a pairwise key according to an embodiment of the present invention.

### DETAILED DESCRIPTION OF THE INVENTION

The present invention will now be described more fully with reference to the accompanying drawings, in which exemplary embodiments of the invention are shown. Like reference numerals in the drawings denote like elements, and thus their description will be omitted. Detailed descriptions related to well-known functions or configurations will not be described in order not to unnecessarily obscure the subject matter of the present invention.

Also, unless otherwise indicated, the terms “include” and “comprise,” as well as derivatives thereof, mean inclusion without limitation.

In a typical tree routing in a sensor network, a routing path is determined in a direction from each node to a sink node. However, since a path cannot be determined in a direction from a sink node to each node, in this case it is necessary to transmit a message through broadcasting.

The present invention provides a more efficient and safe key management method by expanding a conventional tree routing such that any sensor node can set a pairwise key without using broadcasting. The present invention also provides an efficient message exchange method for the case where memory for a routing table is not sufficient.

The efficient and safe key management mechanism and safe communication environment can be provided to a user to realize a safe sensor network through the expanded tree routing by supporting a bi-directional communication between a sink node and sensor nodes.

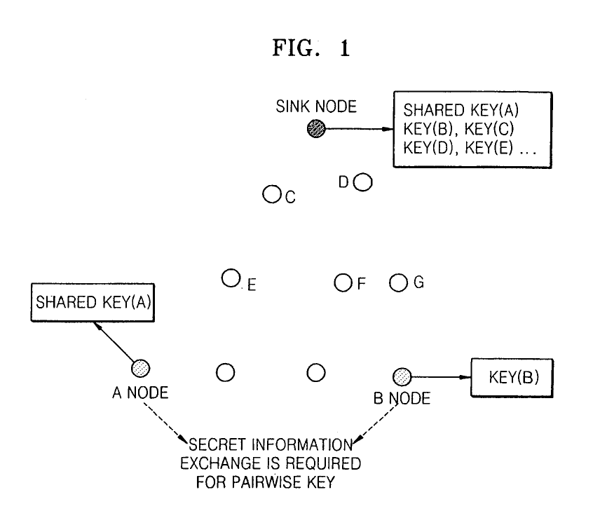

FIGS. 1 through 4 are views illustrating a method of establishing a pairwise key between two nodes in a sensor network system according to an embodiment of the present invention.

Referring to FIG. 1, a sensor network is configured by a sink node and sensor nodes that are cluster nodes. A process of setting a path from sensor nodes to a sink node is well known and is based on a tree routing (Standard Route, MintRoute, Reliable Route) realized in TinyOS.

Hereinafter, a process of setting a path of a tree routing will be described in detail.

Each node included in a sensor network periodically broadcasts a HELLO message. Neighbor nodes of the sink node select the sink node as a parent node through the broadcast message from the sink node. Next, neighbor nodes of the sink node each broadcast a HELLO message again to become parent nodes of other neighbor nodes. Every node selects its own parent node by repeating such a process, and eventually every node sets a path to the sink node through the parent node connection.

Hereinafter, a method of expanding a tree routing for a pairwise symmetric key management will be described according to the present invention.

A pairwise key means a key shared between any two nodes and used for a secret communication and authentication between the two nodes. It is assumed that shared keys are previously distributed between the sink node and the other nodes.

A routing path should be set between an A node and a B node in order to set a pairwise symmetric key therebetween. However, only a routing path from each node to the sink node is set in a sensor network tree routing. In this case, the A node should broadcast a message including data in order to transmit the data to the B node or receive the data.

In addition, in order to safely transmit data by encoding, data should be encoded using a shared key between the sink node and the A node and transmitted to the sink node through broadcasting, and then the sink node should encode the data using a shared key between the sink node and the B node to transmit a message through broadcasting. Therefore, as broadcasting messages are successively generated, the efficiency of an entire sensor network may be decreased.

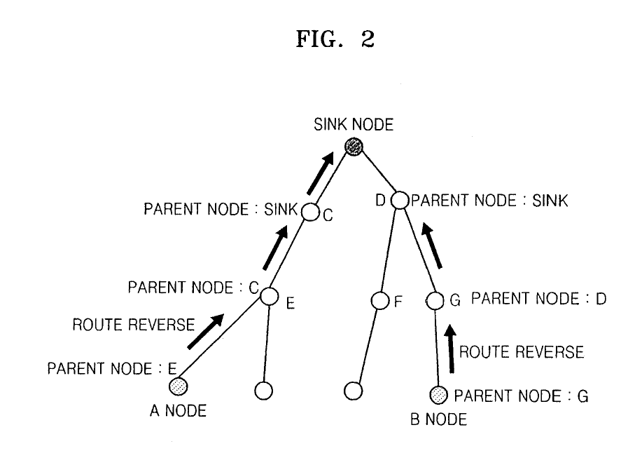

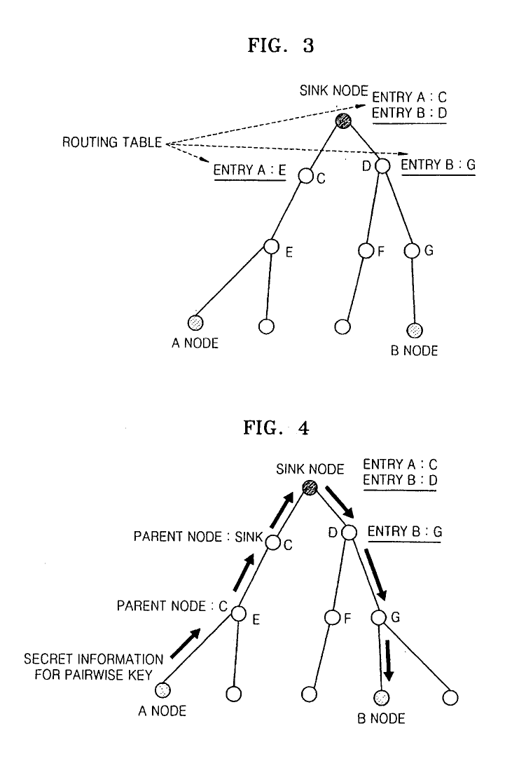

Referring to FIGS. 2 and 3, each sensor node transmits a Route Reverse message toward the sink node when its parent node is determined. An ID of a transmitter node of a message is included in the Route Reverse message. Upper parent nodes of a tree structure receiving the Route Reverse message record ID information of a transmitter node in the message and ID information of an immediately previous relay node on a routing table. Since every node transmits the Route Reverse message when its parent node is determined, every parent node has information of a child node in the routing table.

The sensor nodes transmit the Route Reverse message when the parent nodes are initially determined. The sensor node transmits the Route Reverse message to the sink node as a destination address when the determined parent node is changed. Through the process, a reverse tree routing path from the sink node to the sensor nodes is set opposite to the tree routing path from the sensor nodes to the sink node.

When the sink node or neighbor nodes of the sink node have sufficient memory, new entry may be added to entry of the routing table. However, when memory for the routing table is not sufficient, child nodes cannot be added any more. Therefore, although a node receives the Route Reverse message, it changes (updates) the routing table, but does not add an entry. For example, the node deletes the current entry and updates the routing table by overwriting the new entry into the routing table. The Route Reverse message is continuously transmitted toward the sink node.

Since every path between sensor nodes is set to pass through the sink node, an algorithm for the routing path to the sink node can employ a conventional sensor network routing algorithm. An algorithm for a routing path from the sink node to the sensor nodes has been described with reference to FIGS. 2 and 3.

The A node and the B node can exchange secret information with each other in order to establish a pairwise key through the above-described expanded tree routing.

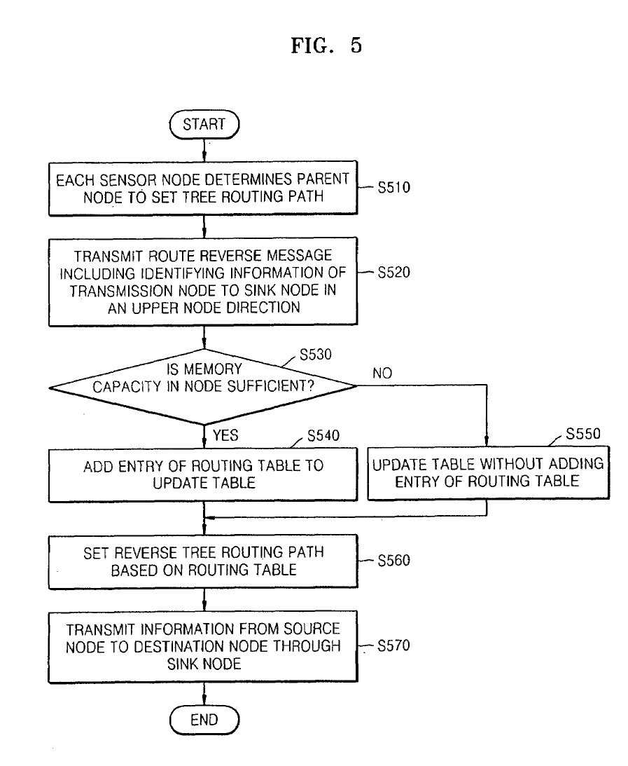

Referring to FIG. 4, a path for transmitting information from the A node to the B node is illustrated. The path from the A node to the sink node or the path from the sink node to the B node are set by using the method of setting a routing path based on the routing table. In order to exchange secret information, a security communication channel should be obtained between the A node and the B node. Here, since the communication therebetween passes through the sink node, the security channel can be obtained using a shared key.

That is, when the A node transmits its secret information to the sink node, the information is encoded using a shared key between the A node and the sink node, and the sink node decodes the information. Then, when the sink node transmits the information to the B node, the information is encoded using a shared key between the B node and the sink node. When the secret information is exchanged between the A node and the B node, a pairwise key for a secret communication between the A node and the B node can be generated.

When the sink node searches the routing table in order to transmit the secret information for establishing a pairwise key to the B node and entry of the B node does not exist, the sink node transmits the secret information message through broadcasting.

When the sink node has the entry of the B node and does not have the entry of its directly connected lower child node to the directly connected lower node, the sink node transmits the message in a unicast mode and the directly connected child node broadcasts the message, thereby reducing overload due to broadcasting.

Since the routing table of the present invention has the structure where the routing entry is formed for only child nodes, the broadcasting message from the node included in the routing entry is not relayed so that a chance of network flooding due to broadcasting can be reduced. Here, the child node includes every connected node downward through a plurality of hops as well as directly connected lower neighbor nodes in a tree structure.

FIG. 5 is a flowchart illustrating a method of setting a reverse tree routing path in a sensor network according to an embodiment of the present invention.

Referring to FIG. 5, a tree routing path is set in a sensor network (S510). When a sink node broadcasts a HELLO message, level 1 nodes that are neighbor nodes of the sink node determine the sink node as a parent node. When each level 1 node which has determined the parent node broadcasts its HELLO message, level 2 nodes that are neighbor nodes of the level 1 nodes determine the level 1 nodes as parent nodes. The above process is repeated and when the lowermost node determines a parent node, a tree routing path is determined from the lowermost node to the sink node.

Next, a reverse tree routing path is set from the sink node to each sensor node (S520˜S560). In detail, each node which has determined its parent node transmits a Route Reverse message considering the sink node as a final node to the sink node through its parent node along the determined tree routing path (S520). The Route Reverse message includes identifying information of each node that generates and transmits the Route Reverse message. Each parent node relaying the message adds its identifying information thereto and transmits the message to its upper parent node. Therefore, each parent node having received the message may generate entry of the routing table based on identifying information of a transmission node and identifying information of an immediately lower child node which has relayed the identifying information of the transmission node. Each node determines whether its memory capacity is enough to add entry of a child node (S530). When the capacity is sufficient, the entry is added to update the routing table (S540), and when the capacity is not sufficient, the routing table is updated without adding an entry (S550). The reverse tree routing path from the sink node to each node is set based on the routing table (S560). When the parent node is changed, each node transmits the Route Reverse message to the changed parent node so as to update the routing table. The sink node and each node can set the reverse tree routing path to the lower destination node by referring to the entries of the routing table.

When the tree routing path and the reverse tree routing path are set, a source node of any two nodes to share specific information transmit the specific information to the destination node passing through the sink node (S570). The source node transmits information to the sink node in an upper node direction along the tree routing path, and the sink node transmits the information to the destination node in a lower node direction along the reverse tree routing path. Here, the source node encodes information to be transmitted using a shared key with the sink node and transmits the information to the sink node, and the sink node decodes the received information using a shared key with the source node and encodes the information using a shared key with the destination node to transmits the information to the destination node.

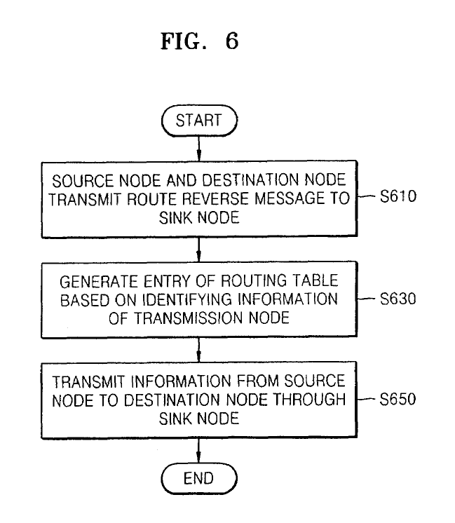

FIG. 6 is a flowchart illustrating a method of setting a path for information transmission between any two nodes to establish a pairwise key according to an embodiment of the present invention.

Referring to FIG. 6, it is assumed that a tree structure is formed between nodes on a path from a source node and a destination node to establish a pairwise key to a sink node.

To establish a pairwise key, each of the source node and the destination node transmits a Route Reverse message including its identifying information and considering the sink node as a final node along a tree path of an upper node direction (S610).

Nodes on each path from the source node and the destination node to the sink node generate an entry in a routing table based on identifying information of a transmission node (source node or destination node) included in the route reverse message and identifying information of an immediately previous relay node (child node) (S630). The nodes on the path determine whether to add entries depending on its memory capacity. When the memory capacity is not sufficient, the nodes update the routing table without adding an entry of a child node.

The source node transmits secret information required for establishing a pairwise key to the destination node along a path passing through the sink node (S650). The information is transmitted from the source node to the sink node along an upper node direction of the tree routing path, and the information is transmitted from the sink node to the destination node along a lower node direction of the reverse tree routing path. The sink node receives the information from the source node, and searches the routing table for the destination node entry. When the destination node entry is included, the sink node transmits the information to the child node that relays the destination node, and when the destination node entry is not included, the sink node broadcasts the information. When the sink node has the destination node entry, and does not have the entry of the neighboring child node, the neighboring child node broadcasts the information. In order to secure the information between the source node and the destination node, the source node encodes the information using a shared key with the sink node to transmit the information to the sink node, and the sink node decodes the information using a shared key with the source node and then encodes the information using a shared key with the destination node to transmit the information to the destination node. Meanwhile, if the nodes on the path between the sink node and the destination node receive the broadcast information, when the entry of the transmission node which has transmitted the broadcast information is included in its routing table, the node determines that the transmission node is its child node and ends the information relay to the child node.

The present invention can provide an efficient and safe key management mechanism and communication environment by providing bi-directional communication between a sink node and sensor nodes through an expanded tree routing, such that a user is provided with a safe sensor network.

That is, a pairwise key for a safe secret communication between any two nodes can be established in a sensor network by using an expanded tree routing protocol according to the present invention. Also, a unicast communication can be performed between specific nodes or between a sink node and a specific node while using characteristics of a conventional tree routing protocol.

In addition, a safe sensor network system can be built and a specific node included in a sensor network can be commanded or controlled to enable the system to be applied to applications requiring a wider range of characteristics.

The invention can also be embodied as computer readable codes on a computer readable recording medium. The computer readable recording medium is any information storage device that can store information, which can be thereafter read by a computer system. Examples of the computer readable recording medium include read-only memory (ROM), random-access memory (RAM), CD-ROMs, magnetic tapes, floppy disks, optical information storage devices, and carrier waves (such as information transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation.

Therefore, the scope of the invention is defined not by the detailed description of the invention but by the appended claims, and all differences within the scope will be construed as being included in the present invention.

What is claimed is:

1. A routing method in a sensor network, the method comprising:
setting a tree routing path to a sink node by determining, at each node in the sensor network, a parent node based on a HELLO message broadcasted by the sink node; and
setting a reverse tree routing path from the sink node by transmitting, at each node which has determined a parent node, a Route Reverse message considering the sink node as a final node to the parent node along the tree routing path.

2. The method of claim 1, wherein the setting of the reverse tree routing path comprises:
transmitting, at each node, a Route Reverse message including its identifying information to the sink node along an upper node direction of a tree routing path;
generating, at parent nodes which have received the Route Reverse message on the path to the sink node, an entry of a routing table based on the identifying information and identifying information of an directly connected lower child node; and
setting a reverse tree routing path from the sink node to each node based on the routing table.

3. The method of claim 2, wherein the generating of the entry of the routing table comprises determining, at each parent node having received the Route Reverse message, whether to add a new entry depending on a memory capacity, and updating the routing table by overwriting the new entry into the routing table when the memory capacity is not sufficient.

4. The method of claim 1, further comprising transmitting, at the node with its parent node changed, the Route Reverse message to the changed parent node.

5. The method of claim 1, further comprising transmitting, at a source node which is to share particular information with a destination node, the particular information to the destination node through the sink node using the reverse tree routing path.

6. The method of claim 5, wherein the transmitting of the particular information comprises:
transmitting, at the source node, the particular information to the sink node along an upper node direction of a tree routing path;
receiving, at the sink node, the particular information and searching the routing table for an entry of the destination node; and
transmitting the particular information to a child node relaying the destination node when the entry of the destination node is included, and broadcasting the particular information when the entry of the destination node is not included.

7. The method of claim 6, wherein the transmitting of the particular information comprises:
transmitting, at the source node, first information generated by encoding the particular information using a shared key with the sink node to the sink node;
decoding, at the sink node, the first information, and generating second information by encoding the decoded first information using a shared key with the destination node; and
searching for, at the sink node, an entry of the destination node to transmit the second information to a child node relaying the destination node when the entry of the destination node is included, and to broadcast the second information when the entry of the destination node is not included.

8. A routing method of setting an information transmission path for establishing a pairwise key in a sensor network of a tree structure, the method comprising:
transmitting, at each of a source node and a destination node to establish a pairwise key, a Route Reverse message including its identifying information and considering a sink node as a final node in a parent node direction of the tree structure;
generating, at nodes having received the Route Reverse message on the transmission path, an entry of a routing table based on the identifying information and identifying information of an directly connected lower child node; and
transmitting, at the source node, information for establishing the pairwise key to the destination node through the sink node using a reverse tree routing path set based on the routing table.

9. The method of claim 8, wherein the generating of the entry of the routing table comprises determining whether to add a new entry depending on a memory capacity of a node, and updating the routing table by generating the new entry into the routing table when the memory capacity is not sufficient.

10. The method of claim 8, wherein the transmitting of the information comprises:
transmitting, at the source node, the information to the sink node in a parent node direction of the tree structure;
receiving, at the sink node, the information and searching the routing table for entry of the destination node; and
transmitting the information to a child node relaying the destination node when the entry of the destination node is included, and broadcasting the information when the entry of the destination node is not included.

11. The method of claim 10, wherein the transmitting of the information comprises:
transmitting, at the source node, first information generated by encoding the information using a shared key with the sink node to the parent node;
decoding, at the sink node, the first information, and generating second information by encoding the decoded information using a shared key with the destination node; and
searching for, at the sink node, an entry of the destination node to transmit the second information to a child node relaying the destination node when the entry of the destination node is included, and to broadcast the second information when the entry of the destination node is not included.

12. The method of claim 11, further comprising broadcasting, at the child node which has received the second information from the sink node, the second information when the entry of the destination node is not included in its routing table.

13. The method of claim 11, wherein a node having received the broadcasted second information ends the message relay when the entry of the node having broadcasted is included in its routing table.

14. The method of claim 8, further comprising transmitting, at the child node having a changed parent node, a Route Reverse message including the identifying information to the changed parent node considering the sink node as a final node.
